(19) United States
(12) Patent Application Publication
(10) Pub. No.: US 2010/0238359 A1
(43) Pub. Date: Sep. 23, 2010

(54) DISPLAY DEVICE AND TELEVISION RECEIVER

(76) Inventor: Yasumori Kuromizu, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/738,295

(22) PCT Filed: Jun. 2, 2008
(86) PCT No.: PCT/JP2008/060142

§ 371 Date: Apr. 16, 2010

(30) Foreign Application Priority Data
Oct. 19, 2007 (JP) 2007-272702

(51) Int. Cl. H04N 5/44; G02F 1/13357

(52) U.S. Cl. 348/725; 362/97.1; 362/97.2; 348/E05.096

(57) ABSTRACT

The display device 10 of the present invention includes a display panel 11 and a backlight device 12 for supplying light to the display panel 11. The backlight device 12 includes a light source 17 and a light reflecting member 20 arranged on a opposite side from a light emitting side of the light source 17. The light source 17 having the light emitting efficiency that becomes highest when the ambient temperature is T1. The light reflecting member 20 has light reflectively that is the lowest in an area directly behind an area where the ambient temperature around the light source 17 becomes T1 and increases toward an end area of the light reflecting member 20.

### TECHNICAL FIELD

The present invention relates to a display device and a television receiver.

### BACKGROUND ART

In a display device using non-light emitting optical components, such as a liquid crystal display device, a backlight device is provided behind a display panel such as a liquid crystal display panel for illuminating the display panel. The backlight device is arranged behind the liquid crystal panel (on a side opposite from a display surface). It includes, for example, a metal chassis, a plurality of fluorescent tubes (e.g., cold cathode tubes), a light reflecting sheet. The chassis has an opening in a surface on the liquid crystal panel side. The fluorescent tubes, which are used as lamps, are housed in the chassis. The light reflecting sheet is arranged on a bottom surface of the chassis for effectively reflecting light emitted from the cold cathode tubes toward the liquid crystal panel.

To achieve high display quality in recent large-screen display devices, a uniform distribution of light by the backlight device is strongly expected. For example, Patent Document 1 discloses a technology for compensating for unevenness in the amount of light (luminance) created by voltage differences in a longitudinal direction of lamps.

The backlight device disclosed in Patent Document illuminates an object to be illuminated by lamps. It includes luminance compensation means that compensates for unevenness of the luminance in the longitudinal direction of the lamps. It further includes a light reflecting portion for directing light from the lamps in certain directions. The luminance compensation means is provided in the light reflecting portion and compensates for the unevenness of the luminance in the longitudinal direction of the lamps by controlling a reflectively of the light reflecting portion.

Patent Document 1: International publication No. WO2004/031647 pamphlet

### Problem to be Solved by Invention

The uneven distribution in the amount of light maybe caused by unevenness in a temperature inside the backlight device (ambient temperature). Generally in a display device that is used in an upright position, heat generated from the lamps creates natural convection. In this case, the backlight device has a temperature gradient that shows a temperature increase from a lower end area toward an upper end area. The lamps used in display devices usually have characteristics of light emitting efficiencies that change according to ambient temperatures. In the backlight device including a plurality of lamps that emit the larger amount of light as the ambient temperature increases, the amount of the emitted light is small in the lower end area where the ambient temperature is relatively low and increases toward the upper end area as the ambient temperature increases. Namely, the amount of light emitted from each lamp changes according to the temperature distribution inside the backlight device and thus the distribution of light becomes uneven.

### DISCLOSURE OF THE PRESENT INVENTION

The present invention was made in view of the foregoing circumstances. An object of the present invention is to provide a display device having a high display quality without display unevenness, the high display quality achieved by maintaining evenness in an amount of light for illumination with a simple configuration. Another object of the present invention is to provide a television receiver having such a display device.

### Means for Solving the Problem

To solve the above problem, a display device of the present invention includes a display panel and a backlight device for supplying light to the display panel. The backlight device includes a light source and a light reflecting member disposed on a side opposite from a light emitting side of the light source. The light source has a light emitting efficiency that becomes the highest when an ambient temperature therearound is T1. The light reflecting member has light reflectivity that is the lowest in an area directly behind an area where the ambient temperature around the light source becomes T1 and increases toward an end area of the light reflecting member.

According to such a display device, the panel surface of the display panel is illuminated with an even amount of light. Therefore, the display device having a high display quality such that the entire display panel has uniform brightness can be provided.

In the backlight device included in the display device, heat generated from the light source creates natural convection. Therefore, it tends to have a temperature gradient that shows a temperature increase from the lower end area toward the upper end area; namely, the temperature therein may be different depending on the areas. The light sources arranged in this backlight device generally have light emitting efficiency that varies according to the ambient temperature. Therefore, the amount of light emitted from the light sources may be different depending on the areas of the backlight device. If the light reflecting member arranged to reflect light emitted from the light sources toward the display panel has even light reflectivity on the entire surface, the amount of the light for illuminating the display panel becomes different from area to area and thus the brightness of the display panel is not uniform.

On the other hand, the light reflecting member of the present invention has the light reflectivity that is the lowest in the area directly behind the area where the ambient temperature becomes T1, at which the light emitting efficiency of the light sources becomes highest. Then, it increases along from the area directly behind the area where the ambient temperature becomes T1 toward the end area of the light reflecting member. Namely, the amount of the light reflected by the light reflecting member is relatively small in the area where the amount of the light emitted from the light sources is relatively large. On the other hand, the amount of the light reflected by the light reflecting member is relatively large in the area where the amount of the light emitted from the light sources is relatively small. As a result, the panel surface of the display panel is illuminated with the even amount of light and thus a high display quality such that the entire display panel has uniform brightness can be provided.

In the display device of the present invention, the area directly behind the area where the ambient temperature around the light sources becomes T1 is located in the upper end area of the light reflecting member. The light reflectivity of the light reflecting member increases along from the upper end area toward the lower end area.

In this configuration, the temperature in the upper end area of the backlight device is equal to the ambient temperature T1 at which the light emitting efficiency of the light sources becomes the highest. The light emitting efficiency of the light sources decreases along from the upper end area of the backlight device toward the lower end area as the ambient temperature decreases. By setting the light reflectivity so as to increase along from the upper end area of the light reflecting member toward the lower end area, a decrease in the amount of the light emitted from the light sources can be compensated with an increase in the amount of the light reflected by the light reflecting member. As a result, the panel surface of the display panel can be illuminated with the even amount of light.

Alternatively, the area directly behind the area where the ambient temperature around the light sources becomes T1 is located in the lower end area of the light reflecting member. The light reflectivity of the light reflecting member increases along from the lower end area toward the upper end area.

The temperature in the lower end area of the backlight device is equal to the ambient temperature T1 at which the light emitting efficiency of the light sources becomes the highest. The light emitting efficiency of the light sources decreases along from the lower end area of the backlight device toward the upper end area as the ambient temperature increases. By increasing the light reflectivity from the lower end area of the light reflecting member toward the upper end area, a decrease in the amount of the light emitted from the light sources can be compensated with an increase in the amount of light reflected by the light reflecting member. As a result, the panel surface of the display panel can be illuminated with the even amount of light.

Further alternatively, the area directly behind the area where the ambient temperature around the light sources becomes T1 is located in the middle area between the upper end area and the lower end area of the light reflecting member. The light reflectivity of the light reflecting member increases along from the middle area toward the upper end area and the lower end area.

The temperature in the middle area of the backlight device is equal to the ambient temperature T1 at which the light emitting efficiency of the light sources becomes the highest. The light emitting efficiency of the light sources decreases along from the middle area of the backlight device toward the upper end area and the lower end area as the ambient temperature increases along from the middle area toward the upper end area and decreases along from the middle area toward the lower end area. By increasing the light reflectivity along from the middle area toward the upper end area and the lower end area of the light reflecting member, a decrease in the amount of light emitted from the light sources can be compensated with the increase in the amount of light reflected by the light reflecting member. As a result, the panel surface of the display panel can be illuminated with the even amount of light.

The backlight device includes a chassis for housing the light sources and the light reflecting member. Light reflectivity of the chassis is lower than that of the light reflecting member. The light reflecting member has a plurality of apertures. An aperture ratio that is a total area of the apertures over that of the light reflecting member is the highest in the area directly behind the area where the ambient temperature around the light sources becomes T1 and decreases toward the end area of the light reflecting member.

With this configuration, some rays of light emitted from the light sources are reflected by the light reflecting member and some rays of light that pass through the apertures of the light reflecting member reach the chassis and then reflect off the chassis. By setting the light reflectivity of the chassis lower than that of the light reflecting member, the amount of the reflected light in the areas where the apertures are provided can be decreased. Namely, with the above configuration, the aperture ratio of the light reflecting member decreases along from the area directly behind the area where the ambient temperature around the light sources becomes T1 toward the end area. The amount of the light reflected by the light reflecting member is the smallest in the area directly behind the area where the ambient light becomes T1 and increases toward the end area. As a result, the amount of the reflected light is small in the area where the light emitting efficiency of the light sources is high, and the amount of the reflected light is large in the area where the light emitting efficiency of the light sources is low. With this complementary relationship, the panel surface of the display panel is illuminated with the even amount of light.

The surface of the chassis that faces the light sources is painted in gray or black.

By applying the gray or black paint that is less likely to reflect light to the chassis, the light reflectivity of the chassis can be reduced. Therefore, the difference in the light reflectively between the chassis and the light reflecting member can be increased and thus a function for adjusting the amount of the reflected light with the apertures can be enhanced.

A gray or black member may be inserted between the light reflecting member and the chassis.

Light emitted from the light sources and passing through the apertures is reflected by this member inserted between the light reflecting member and the chassis. By providing this member in gray or black, the light reflectivity of this member can be reduced. As a result, the difference in the light reflectivity between the member and the light reflecting member can be increased and thus the function for adjusting the amount of the reflected light with the apertures can be enhanced.

The backlight device includes a chassis for housing the light sources and the light reflecting member. The light reflectivity of the chassis is higher than that of the light reflecting member. The light reflecting member has a plurality of apertures. An aperture ratio that is a total area of the apertures over that of the light reflecting member is the lowest in the area directly behind the area where the ambient temperature around the light sources becomes T1 and increases toward the end area of the light reflecting member.

By setting the light reflectivity of the chassis higher than that of the light reflecting member, the amount of the reflected light in the area where the apertures are provided can be increased. With the above configuration, the aperture ratio of the light reflecting member increases along from the area directly behind the area where the ambient temperature of the light sources becomes T1 toward the end area. Therefore, the amount of the light reflected by the light reflecting member is the smallest in the area directly behind the area where the ambient temperature around the light sources becomes T1 and increases toward the end area. As a result, the amount of the reflected light is small in the area where the light emitting efficiency of the light source is high, and it is large in the area where the light emitting efficiency of the light source is low. With this complementary relationship, the panel surface of the display panel is illuminated with the even amount of light.

A surface of the cassis that faces the light sources may be painted with a fluorescent whitening agent.

Alternatively, the surface that faces the light sources may be coated with a vapor-deposited metal so as to shine.

By applying the fluorescent whitening agent that is more likely to reflect light or by coating with the vapor-deposited metal and making the surface shiny, the light reflectivity of the chassis can be increased. As a result, the difference in the light reflectivity between the chassis and the light reflecting member can be increased and thus the function for adjusting the amount of the reflected light with the apertures can be enhanced.

Alternatively, a member to which a fluorescent whitening agent is applied is inserted between the light reflecting member and the chassis.

Further alternatively, a member to which a metal is vapor-deposited to make its surface shiny may be inserted between the light reflecting member and the chassis.

Light emitted from the light sources passes through the apertures and reflects off the member inserted between the light reflecting member and the chassis. By applying the fluorescent whitening agent that is more likely to reflect light or by vapor-depositing the metal to the member to make the surface shiny, the light reflectivity of the member can be increased. As a result, the difference in the light reflectivity between the member and the light reflecting member can be increased and thus the function for adjusting the amount of the reflected light with the apertures can be enhanced.

The apertures are provided in areas of the light reflecting member directly behind the light sources.

The brightness in areas where the apertures are provided is significantly different from that in normal areas around the apertures (i.e., areas where the apertures are not provided). Therefore, shadows of the apertures may be viewed when images are displayed on the display device. By providing the apertures in the areas directly behind the light sources (in the areas that overlap the light sources), the light sources exist between a viewer's eyes and the apertures. Thus, the apertures are less likely to be viewed.

The aperture ratio can be controlled by any one of or a combination of an interval between the apertures, a size of the apertures and a shape of the apertures.

With such a simple means, that is, by changing the interval between the apertures, the size of the apertures, or the shape of the apertures, the preferable aperture ratio can be easily achieved.

Light source holding portions for holding the light sources to the chassis are also provided. The light reflecting member has insertion holes through which the light holding portions are inserted. A size of the apertures and that of the insertion holes are different from each other.

Namely, the light reflecting member has the apertures and apertures (insertion holes) having a different function from that of the apertures. By providing them in different sizes, the apertures are distinguished from the insertion holes. Thus, they are not mixed up with each other during assembly of the display device and simplification of the manufacturing process is expected.

Light source holding portions for holding the light sources to the chassis are also provided. The light reflecting member has insertion holes through which the light holding portions are inserted. A shape of the apertures and that of the insertion holes are different from each other.

Namely, the light reflecting member has the apertures and apertures (insertion holes) having a different function from that of the apertures. By providing them in different shapes, the apertures are distinguished from the insertion holes. Thus, they are not mixed during assembly of the display device and simplification of the manufacturing process is expected.

A plurality of apertures can be formed in a zigzag arrangement.

Alternatively, the plurality of apertures can be formed in a parallel arrangement.

With the above configuration, the apertures are regularly arranged and thus an accuracy of adjustment of the amount of the reflected light can be improved.

The apertures can be formed by punching the light reflecting member.

The apertures can be formed by plotter cutting the light reflecting member.

The apertures can be formed by laser processing the light reflecting member.

By forming the apertures by punching, plotter cutting or laser processing, the apertures can be designed as appropriate and easily formed as designed.

The light reflecting member can have a dot pattern that includes a plurality of dots. The light reflectivity of the dot pattern is lower than that of the light reflecting member. A dot pattern occupancy that is a percentage of area of the dot pattern over the total area of the light reflecting member is the highest in the area directly behind the area where the ambient temperature around the light source becomes T1. Then, it decreases from the area directly behind the area where the ambient temperature becomes T1 toward the end area of the light reflecting member.

With this configuration, some rays of light emitted from the light sources are reflected by the surface of the light reflecting member and some rays are reflected by the dots in the dot pattern formed on the light reflecting member. By setting the light reflectivity of the dots lower than that of the light reflecting member, the amount of the light reflected by the dot pattern can be reduced. With the above configuration, the dot pattern occupancy decreases from the area directly behind the area where the ambient temperature around the light sources becomes T1 toward the end area. Therefore, the amount of the light reflected by the light reflecting member is the smallest in the area directly behind the area where the ambient temperature around the light sources becomes T1 and increases toward the end area. As a result, the amount of the reflected light is small in the area where the light emitting efficiency of the light sources is high, and it is large in the area where the light emitting efficiency of the light sources is low. With this complementary relationship, the panel surface of the display panel is illuminated with the even amount of light.

The dot pattern is provided in gray or black.

By providing the dot pattern in gray or black, which is less likely to reflect light, the light reflectivity of the dots is reduced. Therefore, the difference in the light reflectivity between the dots and the light reflecting member becomes significant and thus a function for adjusting the amount of the reflected light with the dot pattern can be enhanced.

The light reflecting member can have dot pattern, the light reflectivity of which is higher than that of the light reflecting member. A dot pattern occupancy that is a percentage of area of the dot pattern over the total area of the light reflecting member is the lowest in an area directly behind the area where the ambient temperature around the light source becomes T1. Then, it increases along from the area directly behind the area where the ambient temperature becomes T1 toward the end area of the light reflecting member.

By setting the light reflectivity of the dots higher than that of the light reflecting member, the amount of the light reflected by the dot pattern can be increased. With the above configuration, the dot pattern occupancy increases along from the area directly behind the area where the ambient temperature around the light sources becomes T1 toward the end area. Therefore, the amount of the light reflected by the light reflecting member is the smallest in the area directly behind the area where the ambient temperature around the light sources becomes T1 and increases toward the end area. As a result, the amount of the reflected light is small in the area where the light emitting efficiency of the light sources is high, and it is large in the area where the light emitting efficiency of the light sources is low. With this complementary relationship, the panel surface of the display panel is illuminated with the even amount of light.

The dot pattern is formed with a fluorescent whitening agent applied thereto.

By forming the dot pattern with the fluorescent whitening agent, which is more likely to reflect light, the light reflectivity of the dots is increased. As a result, the difference in the light reflectivity between the dots and the light reflecting member is increased. Thus, the function for adjusting the amount of the reflected light with the dot pattern can be enhanced.

The dot pattern is provided in the area of the light reflecting member directly behind the light sources.

The brightness in the areas where the dot pattern is formed may be significantly different from that in normal areas around the areas (i.e., in the areas where the apertures are not formed). Thus, a shadow of the dot pattern may be viewed when displaying images on the display device. By providing the dot pattern directly behind the light sources (in locations that overlap the light sources), the light sources exist between the viewer's eyes and the dot pattern. Therefore, the dot pattern is less likely to be viewed.

The dot pattern occupancy can be controlled by any one of or a combination of an interval between the dots, a size of the dots and a shape of the dots.

With such a simple means, that is, by changing the interval between the dots, the size of the dots, or the shape of the dots, the preferable dot pattern occupancy can be easily achieved.

The dot pattern can include a plurality of dots formed in a zigzag arrangement.

The dot pattern can include a plurality of dots formed in a parallel arrangement.

With the above configuration, the dots are regularly arranged and thus an accuracy of adjustment of the amount of the reflected light can be improved.

The dot pattern can be formed by printing on the light reflecting member.

The dot pattern can be formed by vapor depositing a metal on the light reflecting member.

By forming the dot pattern by printing or vapor deposition of metal, the dot pattern can be designed as appropriate and the dot pattern is easily formed as designed.

The light sources are a plurality of linear light sources arranged in parallel. Arrange intervals of the linear light sources are smaller in the lower end area of the backlight device than those in the upper end area of the backlight device.

The amount of heat generated in the area where the linear light sources are arranged at small intervals is larger than that in the area where the linear light sources are arrange at large intervals. Therefore, the ambient temperature in the area where the intervals are small tends to increase. By setting the intervals of the liner light sources arranged in the lower end area of the backlight device smaller than that of the linear light sources arranged in the upper end area, the backlight device is less likely to have a temperature gradient that shows an increase in the ambient temperature from the lower end area toward the upper end area, which is generally occurs in known backlight devices. As a result, the even amount of light is emitted from the light sources.

The display panel is a liquid crystal panel using liquid crystal.

The display device including the liquid crystal panel can be used for various applications of liquid crystal display devices such as a television and a computer monitor. This display device is especially preferable for a large screen application.

A television receiver of the present invention includes the above-described display device.

According to such a television receiver, cost saving related to the display device is possible and therefore cost saving related to the television receiver is possible.

### EFFECT OF THE INVENTION

According to the present invention, the light sources are driven in parallel and the configuration for driving them in parallel is simplified. As a result, a lighting device for a display device that contributes to a significant cost reduction with a low failure rate and high reliability is provided. Further a display device including the lighting device for a display device with high reliability can be provided at a reasonable price. Still further, a television receiver including the display device with high reliability can be provided at a reasonable price.

### BRIEF DESCRIPTION OF THE DRAWINGS

FIG. 1 is an exploded perspective view illustrating a general construction of a television receiver according to the first embodiment of the present invention;

FIG. 2 is an exploded perspective view illustrating a general construction of a liquid crystal display device included in the television receiver in FIG. 1;

FIG. 3 is a cross-sectional view of the liquid crystal display device in FIG. 2 along the line A-A;

FIG. 4 is a chart illustrating a relationship between an ambient temperature around cold cathode tubes included in the liquid crystal display device in FIG. 2 and a light emitting efficiency thereof;

FIG. 5 is a schematic plan view illustrating a construction of a light reflecting sheet arranged in the liquid crystal display device in FIG. 2;

FIG. 6 is an explanatory view schematically illustrating operational effects of the light reflecting sheet in FIG. 5;

FIG. 7 is a schematic plan view illustrating a construction of a light reflecting sheet arranged in a liquid crystal display device according to the second embodiment of the present invention;

FIG. 8 is an explanatory view schematically illustrating operational effects of the light reflecting sheet in FIG. 7;

FIG. 9 is a plan view illustrating a modification of the light reflecting sheet;

FIG. 10 is a plan view illustrating a modification of the light reflecting sheet;

FIG. 11 is a schematic plan view illustrating a construction of a light reflecting sheet arranged in a liquid crystal display device according to the third embodiment of the present invention;

FIG. 12 is an explanatory view schematically illustrating operational effects of the light reflecting sheet in FIG. 11;

FIG. 13 is a schematic plan view illustrating a construction of a light reflecting sheet arranged in a liquid crystal display device according to the fourth embodiment of the present invention; and

FIG. 14 is an explanatory view schematically illustrating operational effects of the light reflecting sheet in FIG. 13.

### EXPLANATION OF SYMBOLS

10: Liquid crystal display device (Display device), 11: Liquid crystal panel (Display panel), 12: Backlighting device, 14, 34: Chassis, 17: Cold cathode tube (Light source), 17a: Narrow pitch area, 17b: Wide pitch area, 19: Lamp clip (Light source holding portion), 20, 30: Light reflecting sheet (Light reflecting member), 21: Insertion hole, 22: Aperture, 31: Dot, TV: Television receiver.

### BEST MODE FOR CARRYING OUT THE INVENTION

### First Embodiment

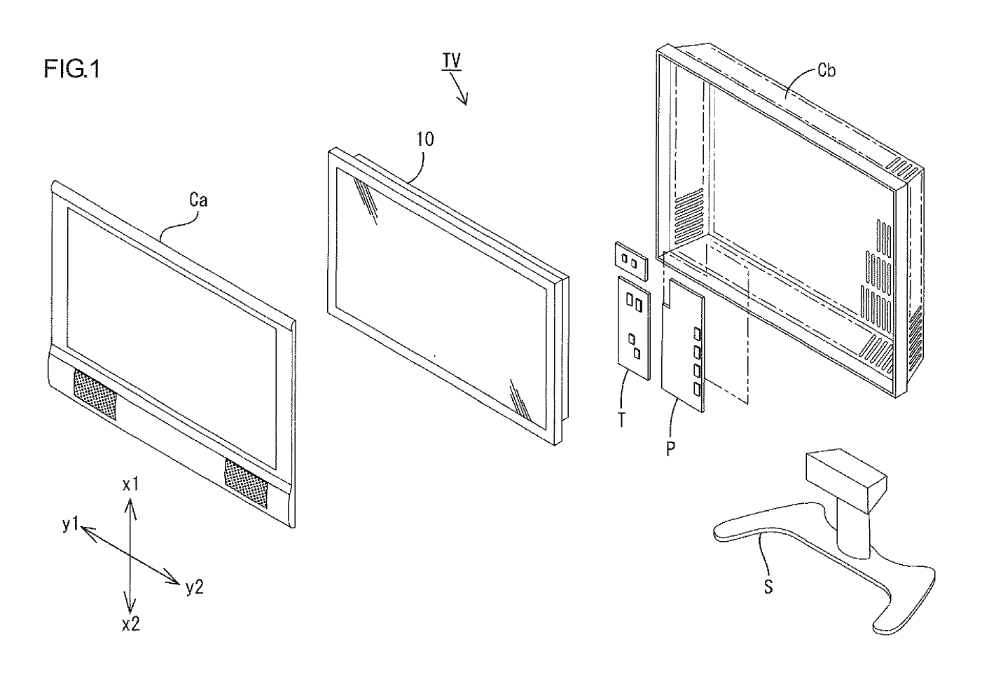

The first embodiment of the present invention will be explained with reference to FIGS. 1 to 6. In this embodiment, a television receiver TV including a liquid crystal display device 10 will be explained.

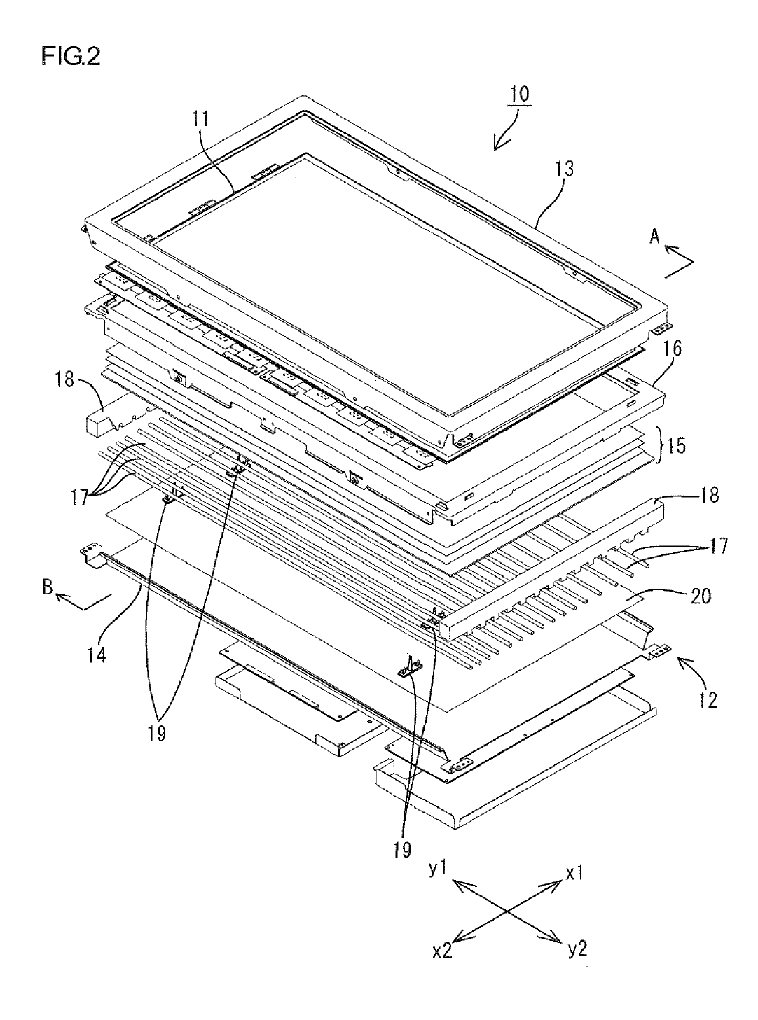

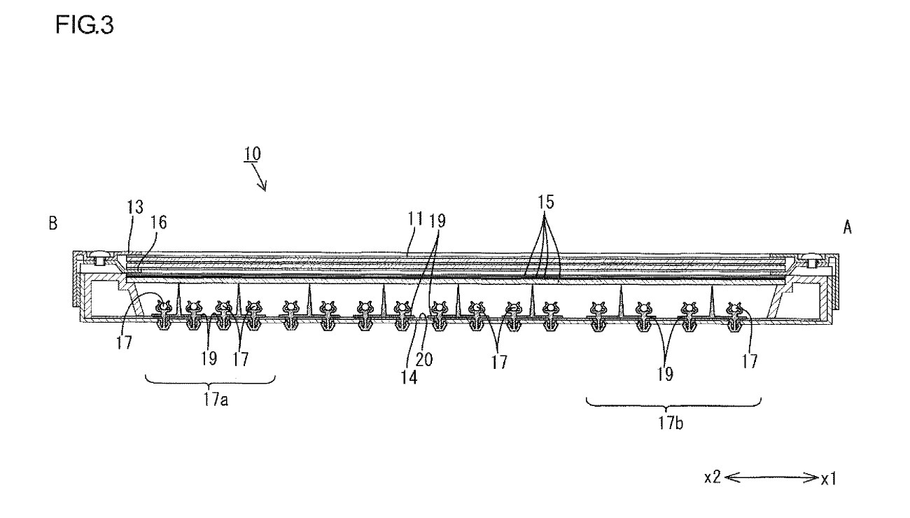

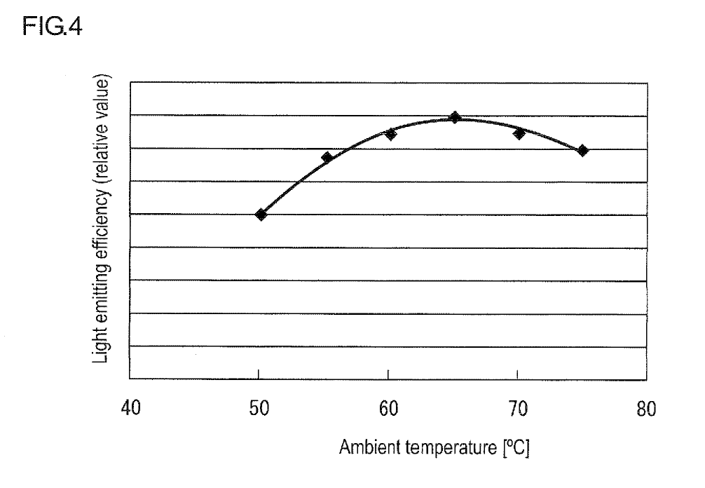

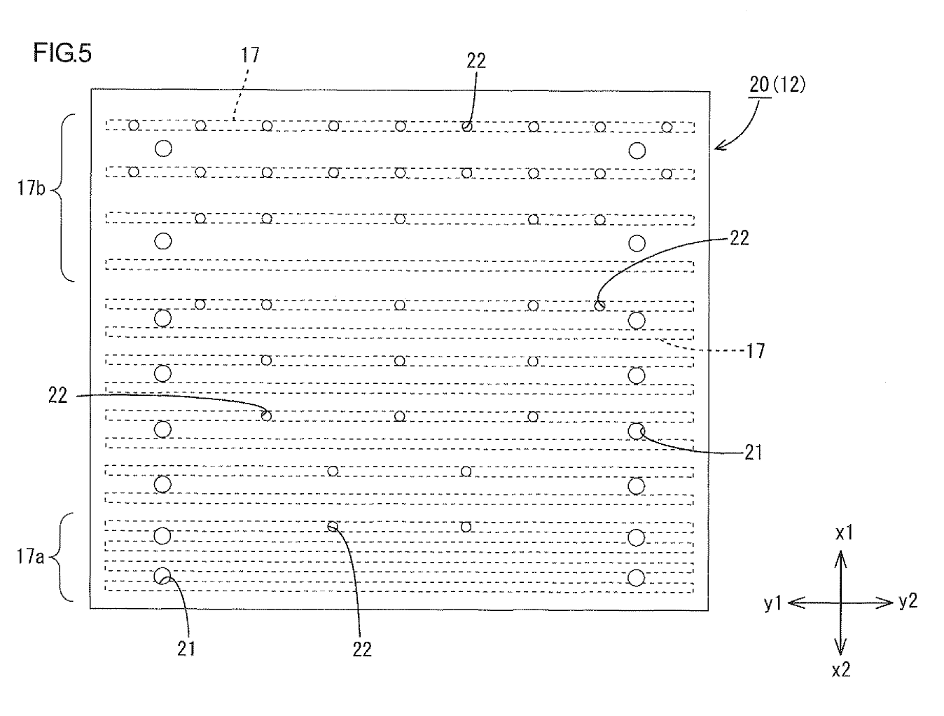

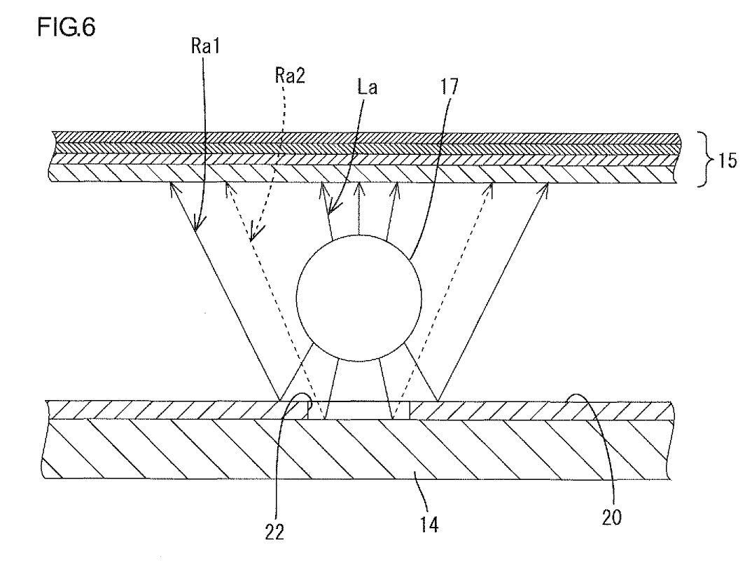

FIG. 1 is an exploded perspective view illustrating a general construction of a television receiver according to this embodiment. FIG. 2 is an exploded perspective view illustrating a general construction of a liquid crystal display device. FIG. 3 is a cross-sectional view of the liquid crystal display device along the line A-A. FIG. 4 is a chart illustrating a relationship between an ambient temperature around cold cathode tubes included in the liquid crystal display device and a light emitting efficiency of the cold cathode tubes. FIG. 5 is a schematic plan view illustrating a construction of a light reflecting sheet arranged in the liquid crystal display device. FIG. 6 is an explanatory view schematically illustrating operational effects of the light reflecting sheet. An x1-x2 axis and an y1-y2 axis are specified in some drawings and illustrations are drawn in orientation along the axes.

As illustrated in FIG. 1, the television receiver TV of the present embodiment includes a liquid crystal display device 10, front and rear cabinets Ca, Cb that house the liquid crystal display device 10 therebetween, a power source P, a tuner T and a stand S. An overall shape of the liquid crystal display device (display device) 10 is a landscape rectangular. The liquid crystal display device is housed in a vertical position such that a short-side direction is aligned with a vertical line. As illustrated in FIG. 2, it includes a liquid crystal panel 11, which is a display panel, and a backlight device 12, which is an external light source. They are integrally held by a bezel 13 and the like.

Next, the liquid crystal panel 11 and the backlight device 12 included in the liquid crystal display device 10 will be explained (see FIGS. 2 and 3).

The liquid crystal panel 11 has a configuration such that a pair of glass substrates is bonded together with a predetermined gap therebetween and liquid crystal is sealed between the glass substrates. On one of the glass substrates, switching components (e.g., TFTs) connected to source lines and gate lines that are perpendicular to each other and pixel electrodes connected to the switching components are provided. On the other substrate, counter electrodes, color filter having color sections such as R, G and B color sections arranged in a predetermined pattern and the like are provided.

The backlight device 12 is a so-called direct backlight device in which a light source is arranged closely behind a panel surface (i.e., a display surface) of the liquid crystal panel 11. It includes a plurality of tubular light sources (cold cathode tubes (light sources) 17 are used as high-pressure discharge tubes here) along the panel surface.

The backlight device 12 further includes a chassis 14, a plurality of optical members 15 (a diffuser plate, a diffusing sheet, a lens sheet and a reflection type polarizing plate, arranged in this order from the lower side of the drawings) and a frame 16. The chassis 14 has a substantially box-shape and an opening on the top. The optical members 15 are arranged so as to cover the opening of the backlight chassis 14. The frame 16 holds the optical members 15 to the backlight chassis 14. The cold cathode tubes 17, lamp holders 18 that cover ends of the cold cathode tubes 17 collectively, and lamp clips (light source holding member) 19 for mounting the cold cathode tubes 17 to the chassis 14 are installed in the chassis 14. A light emitting side of the backlight device 12 is a side closer to the optical member 15 than the cold cathode tube 17.

The cold cathode tubes 17 have an elongated tubular shape. A plurality of them (sixteen tubes in FIG. 2) are housed in the chassis 14 such that the longitudinal direction (i.e., the axial direction) thereof is aligned with the longitudinal direction of the chassis 14. Each cold cathode tube 17 used in this embodiment has characteristics such that a light emitting efficiency thereof and an ambient temperature therearound have a correlation illustrated in FIG. 4. The ambient temperature T1 is equal to 65 degrees Celsius when the light emitting efficiency (relative luminance) is the highest.

As illustrated in FIG. 3, the cold cathode tubes 17 are arranged at a relatively small interval in a narrow pitch area 17a located in a lower end area of the backlight device 12 (on the B side in FIG. 3). They are arranged at a relatively large interval in a wide pitch area 17b located in an upper end area of the backlight device 12 (on the A side in FIG. 3). More specifically, the gap between the adjacent cold cathode tubes 17 gradually becomes larger from the lower end area (on the x2 side) of the backlight device 12 toward the upper end area (on the x1 side).

Furthermore, the backlight device 12 has a temperature gradient that shows a gradual temperature drop along from the upper end area toward the lower end area inside. Specifically, the ambient temperature around the cold cathode tubes 17 arranged in the upper end area is 65 degrees Celsius while the ambient temperature around the cold cathode tubes 17 arranged in the lower end area is 60 degrees Celsius.

The chassis 14 is constructed of metal plates and an inner surface (a surface that faces the cold cathode tubes 17) of the chassis 14 is painted in black. A light reflecting sheet (light reflecting member) 20 is disposed on a side opposite from the light emitting side of the cold cathode tubes 17 so as to form a light reflecting surface. With this chassis 14 including the light reflecting sheet 20, light emitted from the cold cathode tubes is reflected toward the optical members 15 including the diffuser plate.

The light reflecting sheet 20 is a resin sheet having light reflectivity that is higher than the light reflectivity of the chassis 14. The light reflecting sheet 20 is arranged parallel to a plane on which the cold cathode tubes 17 arranged in parallel. As illustrated in FIG. 5, an area of the light reflecting sheet 20 located at one of short-side ends (on the x2 side) faces the narrow pitch area 17a of the cold cathode tubes 17 arrangement.

An area located at the other end (on the x1 side) faces the wide pitch area of the cold cathode tubes 17 arrangement.

Furthermore, the light reflecting sheet 20 has insertion holes 21 for insertion of the lamp clips 19, and apertures 22 for adjustment of the light reflectivity of the light reflecting sheet 20 (the apertures 22 are not shown in FIG. 2). The insertion holes 21 and the apertures 22 are formed in circular shapes, sizes of which are different from each other. With this light reflecting sheet 20, light reflected by the light reflecting sheet 20 is added to the incident light that includes the light directly enters from the cold cathode tubes 17 into the optical members 15. Namely, the incident light is a sum of light La directly entering from the cold cathode tubes 17, light Ra1 reflected by the light reflecting sheet 20, and light Ra2 reflected by the black surface of the chassis 14 after passing through the apertures 22 and reaching the metal chassis 14. Since the light reflectively of the light reflecting sheet 20 is higher than that of the chassis 14, the amount of the light Ra1 is larger than that of the light Ra2. Therefore, the light reflectivity in areas where the apertures 22 are formed is lower than that of the light reflecting sheet 20.

In this embodiment, the apertures 22 are formed in the same size by punching the light reflecting sheet 20. As illustrated in FIG. 5, a plurality of the apertures 22 are provided in a line along the longitudinal direction of the light reflecting sheet 20 (the axial direction of the cold cathode tubes 17 or y1-y2 direction). The apertures 22 form lines in a parallel arrangement along the short-side direction of the light reflecting sheet 20 (the parallel direction of the cold cathode tubes 17 or x1-x2 direction) directly behind the cold cathode tubes 17.

Regarding arrangement intervals of the apertures 22, the interval between the apertures 22 adjacent to each other in the axial direction of the cold cathode tubes 17 is relatively large in the lines located in the lower end area of the light reflecting sheet 20 (on the x2 side), that is, the apertures 22 are formed sparsely. On the other hand, the interval between the apertures 22 adjacent to each other in the axial direction of the cold cathode tubes 17 is relatively small in the lines located in the upper end area of the light reflecting sheet 20 (on the x1 side), that is, the apertures 22 are formed closely with this configuration, an aperture ratio that is a total area of the apertures 22 over that of the light reflecting sheet 20 is the highest in the area directly behind the area where the ambient temperature around the cold cathode tubes 17 becomes T1 and gradually decreases toward the lower end area of the light reflecting sheet 20.

According to the liquid crystal display device 10 or the television receiver TV of the present embodiment with the above configuration, the following operational effects are achieved.

The liquid crystal display device 10 of the present embodiment includes the cold cathode tubes 17 having the light emitting efficiency that becomes the highest at the ambient temperature is T1. The light reflecting sheet 20 disposed on the side opposite from the light emitting side of the cold cathode tubes 17 has the light reflectivity that is the lowest in the area directly behind the area where the ambient temperature becomes T1. The light reflectivity becomes higher along from the area directly behind the area where the ambient temperature becomes T1 toward the end of the light reflecting sheet 20.

With this configuration, the amount of the light reflected by the light reflecting sheet 20 is relatively small in the area where the amount of the light emitted from the cold cathode tubes 17 is relatively large. On the other hand, the amount of the light reflected by the light reflecting sheet 20 is relatively large in the area where the amount of the light emitted from the cold cathode tubes 17 is relatively small. As a result, the panel surface of the liquid crystal panel 11 is illuminated with the even amount of light and thus a high display quality without display unevenness is provided.

According to the present embodiment, the upper end are of the light reflecting sheet 20 is located directly behind the area where the ambient temperature around the cold cathode tubes 17 becomes T1, and the light reflectivity increases along from the upper end area of the light reflecting sheet 20 toward the lower end area.

In this case, the light emitting efficiency of the cold cathode tubes 17 decreases as the ambient temperature decreases along from the upper end area of the backlight device 12 toward the lower end area. By setting the light reflectivity of the light reflecting sheet 20 so as to increase along from the upper end area toward the lower end area, the decrease in the amount of the light emitted from the cold cathode tubes 17 can be compensated with the increase in the amount of the light reflected by the light reflecting sheet 20. Therefore, the panel surface of the liquid crystal panel 11 is illuminated with the even amount of light.

In this embodiment, the light reflectivity of the chassis 14 is lower than that of the light reflecting sheet 20. Moreover, the aperture ratio that is the total area of the apertures 22 over that of the light reflecting sheet 20 is the highest in the area directly behind the area where the ambient temperature around the cold cathode tubes 17 becomes T1 and decreases toward the lower end area of the light reflecting sheet 20.

By providing the apertures 22 in the light reflecting sheet 20, the light emitted from the cold cathode tubes 17 is reflected by the light reflecting sheet 20 or by the chassis when it passes through the apertures 22 provided in the light reflecting sheet 20 and reaches the chassis 14. By setting the light reflectivity of the chassis 14 lower than that of the light reflecting sheet 20, the amount of the reflected light in the areas corresponding to the apertures 22 can be reduced. Namely, with the above configuration, the amount of the reflected light off the light reflecting sheet 20 is the smallest in the areas directly behind the areas where the ambient temperature around the cold cathode tubes 17 becomes T1 and gradually increases toward the ends of the light reflecting sheet 20. As a result, the amount of the reflected light is small in the areas where the light emitting efficiency of the cold cathode tubes 17 is high. On the other hand, the amount of the reflected light is large in the areas where the light emitting efficiency of the cold cathode tubes 17 is low. With this complementary relationship, the panel surface of the liquid crystal panel 11 is illuminated with the even amount of light.

In this embodiment, the surface of the chassis 14 that faces the cold cathode tubes 17 is painted in black.

By applying black paint, which is less likely to reflect light, to the chassis 14, the light reflectivity of the chassis 14 can be reduced. As a result, the difference in the light reflectivity between the chassis 14 and the light reflecting sheet 20 becomes larger. Therefore, a function for adjusting the amount of the reflected light with the apertures 22 can be enhanced.

In this embodiment, the light reflecting sheet 20 has the insertion holes 21 for insertion of the lamp clips 19, and the apertures 22 for adjustment of the light reflectively. The insertion holes 21 and the apertures 22 are formed in circular shapes, sizes of which are different from each other.

By providing the insertion holes 21 in the different size (area size) from the apertures 22, the insertion holes 21 are easily distinguished from the apertures 22. This reduces a possibility of miss-selection between them in an assembly process of the backlight device 12 and thus the manufacturing process is more likely to be simplified.

In this embodiment, the apertures 22 are provided in the light reflecting sheet 20 directly behind the cold cathode tubes 17.

With this configuration, the apertures 22 are less likely to be viewed. Namely, the areas corresponding to the apertures 22 are relatively dark with respect to normal areas around them (i.e., areas not having the apertures 22). As a result, brightness is significantly different between those areas and shadows of the apertures 22 may be viewed while a viewer is watching images displayed on the liquid crystal panel 11. By providing the apertures 22 directly behind (i.e., in areas overlapping) the cold cathode tubes 17, the cold cathode tubes 17 are present between the viewer's eyes and the apertures 22 and thus the shadows of the apertures 22 are less likely to be viewed.

In this embodiment, the aperture ratio of the light reflecting sheet 20 is adjusted by changing intervals between the apertures 22. The aperture ratio is preferably set with such a simple means.

In this embodiment, the apertures 22 are provided in a parallel arrangement. The apertures 22 are regularly arranged and thus an accuracy of adjustment of the amount of the reflected light can be improved.

In this embodiment, the apertures 22 are formed by punching the light reflecting sheet 20. The apertures 22 are easily provided as designed with simple means.

In this embodiment, the arrangement interval of the cold cathode tubes 17 in the lower end area of the backlight device 12 is smaller than that in the upper end area of the backlight device 12.

In this case, the amount of heat generated in the narrow pitch area where the interval between the cold cathode tubes 17 is small is larger than that in the wide pitch area where the interval is large. Therefore, the ambient temperature is more likely to increase in the narrow pitch area. The intervals between the cold cathode tubes 17 in the lower side of the backlight device 12 are set smaller than the intervals between the cold cathode tubes 17 arranged in the upper side. Known backlight devices generally have a temperature gradient that shows a temperature increase along from a lower end area toward an upper area. However, with the above configuration, the backlight device 12 is less likely to have such a temperature gradient, and thus the amounts of light emission from a plurality of the cold cathode tubes 17 can be equalized.

### Second Embodiment

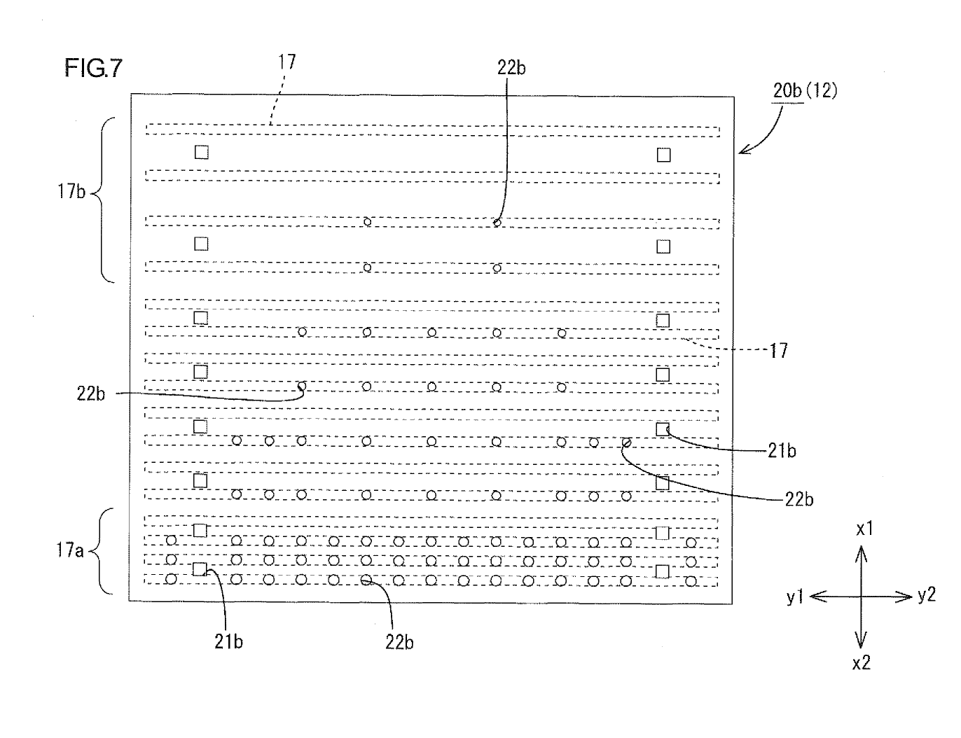

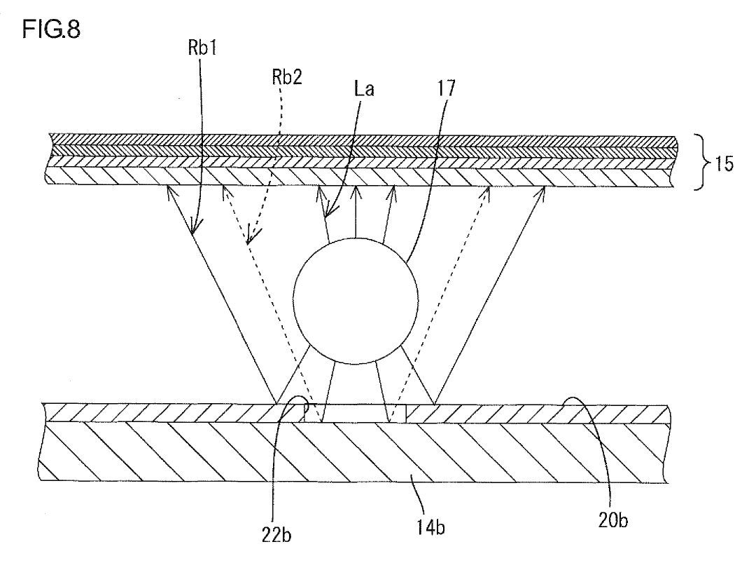

Next, the second embodiment of the present invention will be explained with reference to FIGS. 7 and 8. Differences between this embodiment and the first embodiment are a relationship between the light reflecting sheet and the chassis in terms of the light reflectivity, and configurations of the apertures and the insertion holes. Other configurations are the same as the previous embodiment. The same parts as those in the previous embodiment are indicated by the same symbols and will not be explained.

FIG. 7 is a schematic plan view illustrating a construction of a light reflecting sheet arranged in a liquid crystal display device of the present embodiment. FIG. 8 is an explanatory view schematically illustrating operational effects of the light reflecting sheet.

As illustrated in FIG. 7, each cold cathode tubes 17 has an elongated tubular shape and a plurality of the cold cathode tubes 17 are housed in a chassis 14b with a longitudinal direction thereof is aligned along a longitudinal direction of the chassis 14b. Each cold cathode tube 17 used in this embodiment has characteristics such that a light emitting efficiency thereof and an ambient temperature therearound have a correlation. The ambient temperature T1 is equal to 65 degrees Celsius when the light emitting efficiency (relative luminance) is the highest.

Further, the backlight device 12 has a temperature gradient that shows a gradual temperature drop along from the upper end area (on the x1 side in FIG. 7) toward the lower end area (on the x2 side in FIG. 7) inside. Specifically, the ambient temperature around the cold cathode tubes 17 arranged in the upper end area is 65 degrees Celsius while the ambient temperature around the cold cathode tubes 17 arranged in the lower end area is 60 degrees Celsius.

The chassis 14b of the backlight device 12 is constructed of metal plates. A fluorescent whitening agent is applied to an inner surface of the chassis 14b (a surface that faces the cold cathode tubes 17) and a light reflecting sheet 20b is provided on a side opposite from a light emitting side of the cold cathode tubes 17. These form a light reflecting surface.

The light reflecting sheet 20b is a resin sheet having light reflectivity that is lower than that of the chassis 14b. Further, the light reflecting sheet 20b has insertion holes 21b and apertures 22b for adjustment of the light reflectivity of the light reflecting sheet 20b. The insertion holes 21b are formed in a rectangular shape and the apertures 22b are formed in circular shapes in different sizes.

With he light reflecting sheet 20b arranged on the chassis 14b, light emitted from the cold cathode tubes 17 enters the optical members 15, as illustrated in FIG. 8. Namely, the incident light entering the optical members 15 is a sum of light La that directly enters from the cold cathode tubes 17, light Rb1 reflected by the light reflecting sheet 20b, and Rb2 reflected by the surface of the chassis 14b on which the fluorescent whitening agent is applied after passing through the apertures 22b and reaching the metal chassis 14b. Since the light reflectivity of the light reflecting sheet 20b is lower than that of the chassis 14b, the amount of the light Rb1 is smaller than that of the light Rb2. Therefore, the light reflectivity becomes higher in areas where the apertures 22b are formed.

As illustrated in FIG. 7, the apertures 22b are formed in the same size and in line along a longitudinal direction of the light reflecting sheet 22b (i.e., the axial direction of the cold cathode tubes 17 or the y1-y2 direction).

The apertures 22b that are formed in the axial direction of the cold cathode tubes 17 form a plurality of parallel lines (nine lines in FIG. 7) in the shot-side direction of the light reflecting sheet 22b (i.e., the parallel direction of the cold cathode tubes 17 or the x1-x2 direction). The apertures 22b are relatively large in the lower end area of the light reflecting sheet 22b (on the x2 side), and an interval between the apertures 22b is relatively small. On the other hand, the apertures 22b are relatively small in the upper end area of the light reflecting sheet 22b (on the x1 side), and an interval between the apertures 22b is relatively large. An aperture ratio that is a total area of the apertures 22b over that of the light reflecting sheet 20b is the lowest in the area directly behind the area where the ambient temperature around the cold cathode tubes 17 becomes T1 and increases toward the lower end area of the light reflecting sheet 20b.

According to the liquid crystal display device 10 of the present embodiment, the light reflectivity of the chassis 14b is higher than that of the light reflecting sheet 20b. Moreover, the aperture ratio is the lowest in the area directly behind the area where the ambient temperature around the cold cathode tubes 17 becomes T1 and increases toward the end areas of the light reflecting sheet 20b.

By setting the light reflectivity of the chassis 14b higher than that of the light reflecting sheet 20b, the amounts of reflected light becomes large in the areas where the apertures 22b are formed. Namely, with the above configuration, the aperture ratio is the lowest in the area directly behind the area where the ambient temperature around the cold cathode tubes 17 becomes T1 and increases toward the end areas of the light reflecting sheet 20b. As a result, the amount of the reflected light is small in the area where the light emitting efficiency of the cold cathode tubes 17 is high, and it is large in the area where the light emitting efficiency of the cold cathode tubes 17 is low. With this complementary relationship, the panel surface of the liquid crystal panel 11 is illuminated with the even amount of light.

In this embodiment, the fluorescent whitening agent is applied to the surface the chassis 14b that faces the cold cathode tubes 17.

By applying the fluorescent whitening agent, which is more likely to reflect light, to the chassis 14b, the light reflectivity of the chassis 14b increases. As a result, the difference in the light reflectivity between the chassis 14b and the light reflecting sheet 20b becomes large and the function for adjusting the amount of the reflected light with the apertures 22b is even enhanced.

In this embodiment, the insertion holes 21b and the apertures 22b are formed in different shapes. Therefore, the insertion holes 21b are easily distinguished from the apertures 22b. This reduces the possibility of miss-selection between them in an assembly process of the backlight device 12 and thus the manufacturing process is more likely to be simplified.

In this embodiment, the aperture ratio of the light reflecting sheet 20b is adjusted by changing intervals between the apertures 22b. The aperture ratio is preferably set with such a simple means.

The present invention is not limited to the first and the second embodiments explained in the above description. The following embodiments may be included in the technical scope of the present invention, for example.

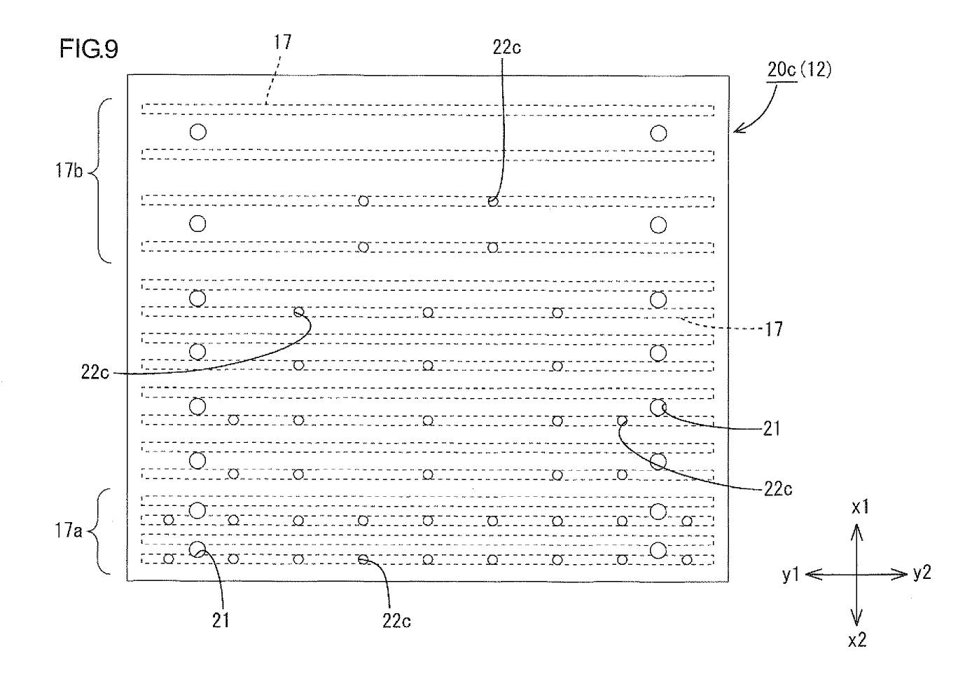

In the first embodiment, the lighting device in which the upper end area of the light reflecting sheet 20 is located directly behind the area where the ambient temperature becomes T1 is explained. However, the present invention can be applied in a case that an area directly behind an area where the ambient temperature becomes T1 is located in a lower end area of a light reflecting sheet 20c. In this case, the light emitting efficiency of the cold cathode tubes 17 decreases along from the lower end area of the light reflecting sheet 20c toward the upper end area and thus forming apertures 22c as illustrated in FIG. 9 is preferable. Namely, forming the apertures 22c such that the aperture ratio is the highest in the lower end area of the light reflecting sheet 20c (on the x2 side) and decreases toward the upper end area (on the x1 side) is preferable.

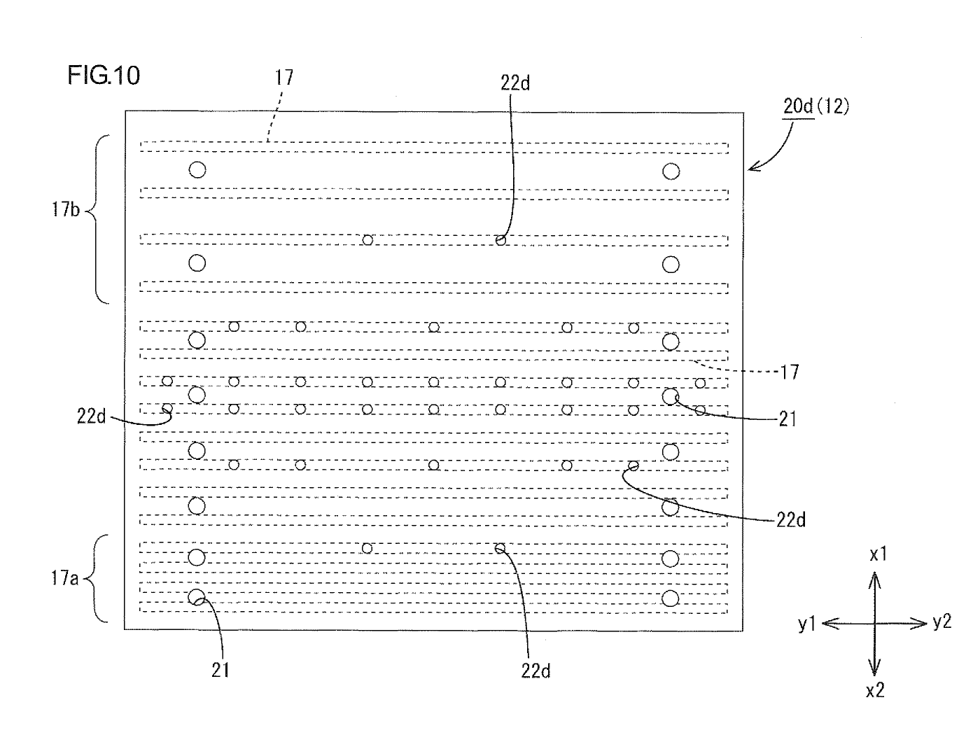

In the first embodiment, the lighting device in which the upper end area of the light reflecting sheet 20 is located directly behind the area where the ambient temperature becomes T1 is explained. However, the present invention can be applied in a case that an area directly behind an area where the ambient temperature becomes T1 is located in a middle area between an upper end area and a lower end are of a light reflecting sheet 20d. In this case, the light emitting efficiency of the cold cathode tubes 17 decreases along from the middle area toward the upper and the lower end areas of the light reflecting sheet 20d and thus forming apertures 22d as illustrated in FIG. 10 is preferable. Namely, forming the apertures 22d such that the aperture ratio is the highest in the middle area in the short-side direction of the light reflecting sheet 20d (the x1-x2 direction) and decreases toward the upper end area (on the x1 side) and the lower end area (on the x2 side) is preferable.

In the first embodiment, the surface of the chassis 14 opposed to the cold cathode tubes 17 is painted in black. However, it can be painted in a different color as long as it is less likely to reflect light, for example, gray. Alternatively, a gray or black member may be inserted between the light reflecting sheet 20 and the chassis 14. In this case, light emitted from the cold cathode tubes 17 passes through the apertures 22 and reflects off a surface of this member.

In the second embodiment, the fluorescent whitening agent is applied to the surface of the chassis 14b, the surface facing the cold cathode tubes 17. However, the surface only needs to become more likely to reflect light. A metal may be deposited on the surface that faces the cold cathode tubes 17 so as to provide a shiny surface.

In the second embodiment, the fluorescent whitening agent is applied to the surface of the chassis 14b, the surface facing the cold cathode tubes 17. However, a member to which the fluorescent whitening agent is applied may be inserted between the light reflecting sheet 20b and the chassis 14b. Alternatively, a member having a shiny surface provided by depositing a metal may be inserted between the light reflecting sheet 20b and the chassis 14b. In this case, light emitted from the cold cathode tubes 17 passes through the apertures 22b and reflects off the surfaces of the respective members.

In the first and the second embodiments, the apertures are formed by punching. However, they may be formed by plotter cutting or laser processing as long as the apertures are formed as designed.

In the first and the second embodiments, the apertures are formed in parallel arrangements. However, they may be formed in zigzag arrangements. Moreover, the apertures are formed in line in the axial direction of the cold cathode tubes in the above embodiment. However, they may be formed in an irregular pattern.

### Third Embodiment

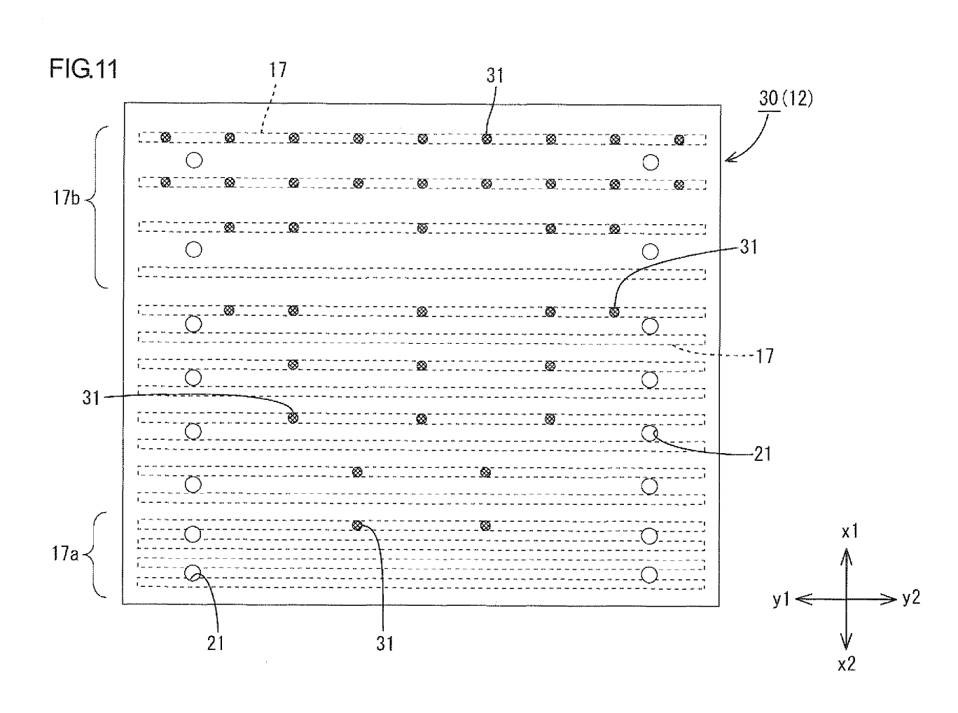

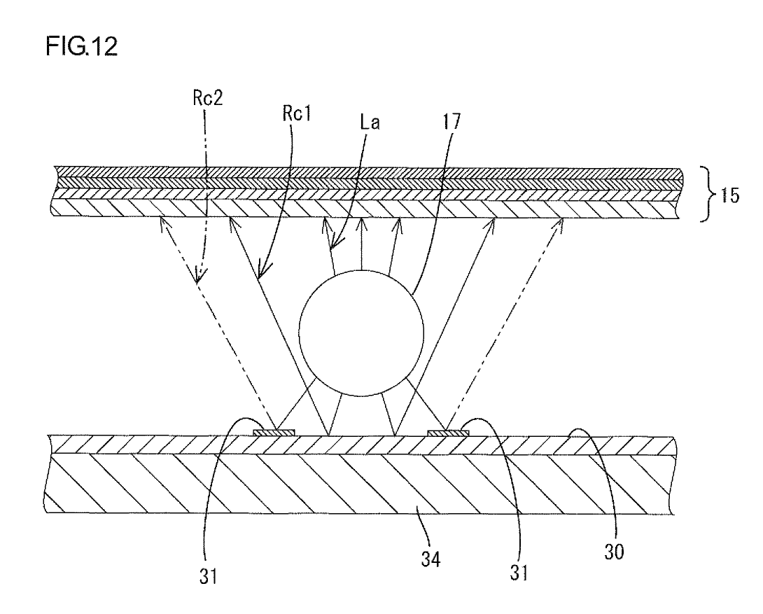

Next, the third embodiment of the present invention will be explained with reference to FIGS. 11 and 12. In the third embodiment, a dot pattern is formed instead of the apertures. Other configurations are the same as the previous embodiments. The same parts as those in the previous embodiment are indicated by the same symbols and will not be explained.

FIG. 11 is a schematic plan view illustrating a construction of a light reflecting sheet arranged in a liquid crystal display device. FIG. 12 is an explanatory view schematically illustrating operational effects of the light reflecting sheet.

As illustrated in FIG. 11, each cathode tube 17 has an elongated tubular shape and a plurality of the cold cathode tubes 17 are housed in a chassis 34 with the longitudinal direction (i.e., an axial direction) aligned along the longitudinal direction of the chassis 34. Each cold cathode tube 17 used in this embodiment has characteristics such that a light emitting efficiency thereof and an ambient temperature therearound have a correlation. The ambient temperature T1 is equal to 65 degrees Celsius when the light emitting efficiency (relative luminance) is the highest.

Further, the backlight device 12 has a temperature gradient that shows a gradual temperature drop along from the upper end area (on the x1 side) toward the lower end area (on the x2 side) inside. Specifically, the ambient temperature is 65 degrees Celsius around the cold cathode tubes 17 arranged in the upper end area and 60 degrees Celsius around the cold cathode tubes 17 arranged in the lower end area.

The chassis 34 is constructed of metal plates. A light reflecting sheet 30 is disposed on a side opposite from a light emitting side of the cold cathode tubes 17 so as to form a light reflecting surface. With the chassis having the light reflecting sheet 30 can reflect light emitted from the cold cathode tubes 17 toward the optical members 15.

The light reflecting sheet 30 is a resin sheet having light reflectivity. Dot patterns including a plurality of black dots 31 are formed on a surface of the light reflecting sheet 30, the surface facing the cold cathode tubes 17. The dots 31 are formed by printing paste of carbon, zinc, titanium oxide and the like on the surface of the light reflecting sheet 30. Inkjet printing, gravure printing and the like are preferable as printing means.

Measurements of the light reflectivity of the dots 31 and the light reflecting sheet 30 are shown in table 1. In table 1, the Light reflectivity column provides the light reflectivity specific to the light reflecting sheet 30 or the dots 31. The dot pattern occupancy column provides a percentage of a total area of the dots 31 over a total area of the light reflecting sheet 30. The average light reflectivity column provides an average of actual measurements of the light reflectivity on the optical member side in a case that the dot patterns are formed on the light reflecting sheet 30 based on the dot pattern occupancy. Measurements of gray dots are also provided as a reference.

### <Table 1>

As shown in table 1, the light reflectivity of the black dots 31 is about 1/15 of the light reflectivity of the light reflecting sheet 30. This indicates that the amount of reflected light can be significantly reduced by printing the black dots 31 on the light reflecting sheet 30. By increasing the dot pattern occupancy of the black dots 31 from 1.4% to 8.5%, the average light reflectivity decreases by 6.5%. This confirms that the dot pattern occupancy functions as a means for adjusting the amount of reflected light.

By providing the light reflecting sheet 30, on which dots 31 are printed, on the chassis 34, light emitted from the cold cathode tubes 17 enters the optical members 15 as illustrated in FIG. 12. The incident light entering the optical members 15 is a sum of light La that enters directly from the cold cathode tubes 17, light Rc1 reflected by the light reflecting sheet 30 and light Rc2 reflected by the black dots 31. Because the light reflectivity of the black dots 31 is significantly low, which is about 1/15 of the light reflectivity of the light reflecting sheet 30, the amount of the light Rc1 is larger than that of the light Rc2. Therefore, the light reflectivity of the light reflecting sheet 30 in areas where the dots 31 are formed is reduced.

As illustrated in FIG. 11, the dots 31 are formed in the same size. They are formed in line along the longitudinal direction of the light reflecting sheet 30 (the axial direction of the cold cathode tubes 17 or the y1-y2 direction). The dots 31 form lines in a parallel arrangement along the short side direction of the light reflecting sheet 30 (i.e., the parallel direction of the cold cathode tubes 17 or the x1-x2 direction).

Regarding intervals of a plurality of the dots 31, an interval between the adjacent dots 31 in the axial direction of the cold cathode tubes 17 is relatively large in the lines located in the lower end area (on the x2 side) of the light reflecting sheet 30, that is, the dots 31 are provided sparsely. On the other hand, in the lines located in the upper end area (on the x1 side) of the light reflecting sheet 30, an interval between the adjacent dots 31 in the axial direction of the cold cathode tubes 17 is relatively small, that is, the dots 31 are provided closely. With this configuration, the dot pattern occupancy is the highest in an area directly behind an area where the ambient temperature around the cold cathode tubes 17 becomes T1, and gradually decreases toward the lower end area of the light reflecting sheet 30.

In the liquid crystal display device 10 of the present embodiment, the light reflectivity of the dots 31 is lower than that of the light reflecting sheet 30. Further, the dot pattern occupancy of the dots 31 on the light reflecting sheet 30, which is a percentage of the total area of the dots 31 over the total area of the light reflecting sheet 30, is the highest in the area directly behind the area where the ambient temperature around the cold cathode tubes 17 becomes T1, and gradually decreases toward the end area of the light reflecting sheet 30.

By providing the dots 31 on the light reflecting sheet 30 in such a manner, the light emitted from the cold cathode tubes 17 is reflected by the light reflecting sheet 30 and by the dots on the light reflecting sheet 30. By setting the light reflectivity of the dots 31 lower than that of the light reflecting sheet 30, the amount of reflected light is reduced in the areas where the dots 31 are formed. With the above configuration, the dot pattern occupancy decreases along from the area directly behind the area where the ambient temperature around the cold cathode tubes 17 becomes T1 toward the end area. The amount of the light reflected by the light reflecting sheet 30 is the smallest in the area directly behind the area where the ambient temperature around the cold cathode tubes 17 becomes T1, and gradually increases toward the end area. As a result, the amount of reflected light is small in the area where the light emitting efficiency of the cold cathode tubes 17 is high, and it is large in the area where the light emitting efficiency of the cold cathode tubes 17 is low. With this complementary relationship, the panel surface of the liquid crystal panel 11 is illuminated with the even amount of light.

In this embodiment, the dots 31 are provided in black.

By forming the dot patterns in black that is less likely to reflect light, the light reflectivity of the dots 31 can be reduced. Therefore, the difference in the light reflectivity between the dots 31 and the light reflecting sheet 30 becomes large and thus a function for adjusting the amount of reflected light with the dot patterns can be enhanced.

In this embodiment, the dot pattern occupancy is controlled by changing the intervals between the dots 31. The dot pattern occupancy is preferably set with such a simple means.

In this embodiment, the dots 31 are formed in a parallel arrangement. Therefore, the dot patterns including the dots 31 formed in a regular arrangement can be formed and thus an accuracy of the adjustment of the amount of reflected light can be improved.

In this embodiment, the dots 31 are formed by printing on the light reflecting sheet 30. Namely, the dot patterns are easily formed as designed with a simple means.

### Fourth Embodiment

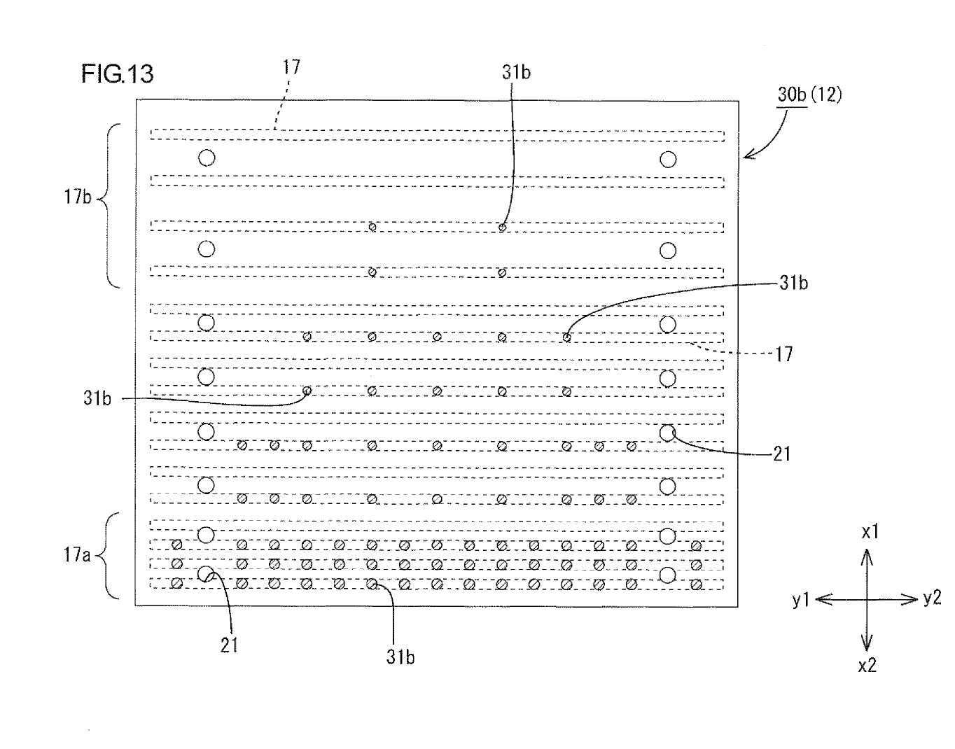

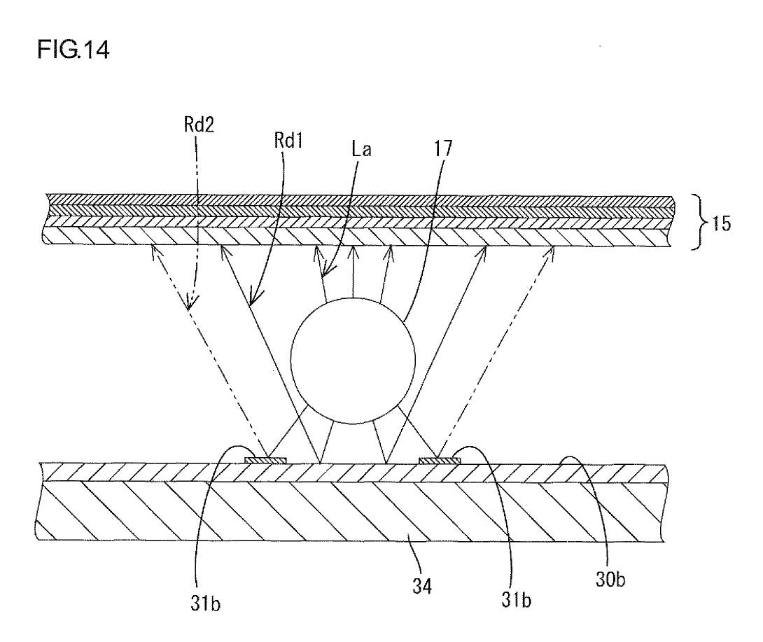

Next, the fourth embodiment of the present invention will be explained with reference to FIGS. 13 and 14. In the fourth embodiment, a relationship between the light reflecting sheet and the dots, and dot patterns are different. Other configurations are the same as the previous embodiments. The same parts as those in the previous embodiment are indicated by the same symbols and will not be explained.

FIG. 13 is a schematic plan view illustrating a construction of a light reflecting sheet arranged in a liquid crystal display device. FIG. 14 is an explanatory view schematically illustrating operational effects of the light reflecting sheet.

As illustrated in FIG. 13, each cathode tube 17 has an elongated tubular shape and a plurality of the cold cathode tubes 17 are housed in a chassis 34 with the longitudinal direction (i.e., an axial direction) aligned along the longitudinal direction of the chassis 34. Each cold cathode tube 17 used in this embodiment has characteristics such that a light emitting efficiency thereof and an ambient temperature therearound have a correlation. The ambient temperature T1 is equal to 65 degrees Celsius when the light emitting efficiency (relative luminance) is the highest.

Further, the backlight device 12 has a temperature gradient that shows a gradual temperature drop along from the upper end area (on the x1 side) toward the lower end area (on the x2 side) inside. Specifically, the ambient temperature is 65 degrees Celsius around the cold cathode tubes 17 arranged in the upper end area and 60 degrees Celsius around the cold cathode tubes 17 arranged in the lower end area.

The light reflecting sheet 30b disposed in the backlight device 12 is a resin sheet having light reflectivity. Dot patterns including a plurality of dots 31b are formed on a surface of the light reflecting sheet 30b, the surface facing the cold cathode tubes 17. The dot patterns are formed by applying fluorescent whitening agent containing stilbene derivative, for example, to the surface of the light reflecting sheet 30b, the surface facing the cold cathode tubes 17.

Measurements of light reflectivity of the dots 31b and the light reflecting sheet 30b are shown in table 2. In table 2, the light reflectivity and the average light reflectivity of the fluorescent agent are measured by applying visible light or ultraviolet light to the dots 31b.

### <Table 2>

As shown in table 2, the light reflectivity of the dots 31b that are formed by applying the fluorescent whitening agent is higher than that of the light reflecting sheet 30b. By printing the dots 31b with the fluorescent whitening agent on the light reflecting sheet 30b, the amount of reflected light can be increased.

By providing the light reflecting sheet 30b, on which such dots 31b are formed, in the chassis 34, light emitted from the cold cathode tubes 17 enters the optical members 15, as illustrated in FIG. 14. Incident light entering the optical members 15 is a sum of light La that enters directly from the cold cathode tubes 17, light Rd1 reflected by the light reflecting sheet 30b and light Rd2 reflected by the dots 31b. Because the light reflectivity of the dots 31b, which are formed by applying the fluorescent agent, is higher than that of the light reflecting sheet 30b, the amount of the light Rd2 is larger than that of the light Rd1. Therefore, the light reflectivity of the light reflecting sheet 30b in areas of where the dots 31b are provided is increased.

The dots 31b are formed in line along the longitudinal direction of the light reflecting sheet 30b (the axial direction of the cold cathode tubes 17 or the y1-y2 direction) and in the same size.

The dots 31b form lines (13 lines in FIG. 13) in a parallel arrangement along the short side direction of the light reflecting sheet 30b (i.e., the parallel direction of the cold cathode tubes 17 or the x1-x2 direction). The dots 31b are relatively large in size in the lower end area (on the x2 side) of the light reflecting sheet 30b and the interval between the dots 31b is relatively small. On the other hand, the dots 31b are relatively small in size in the upper end area (on the x1 side) of the light reflecting sheet 30b and the interval between the dots 31b is relatively large. With this configuration, the dot pattern occupancy of the dots 31b is the lowest in the upper end area of the light reflecting sheet 30b, that is, in the area where the ambient temperature around the cold cathode tubes 17 becomes T1, and gradually increases toward the lower end area of the light reflecting sheet 30b.

In the liquid crystal display device 10 of the present embodiment, the light reflectivity of the dots 31b is higher than that of the light reflecting sheet 30b. Further, the dot pattern occupancy of the dots 31b on the light reflecting sheet 30b, which is a percentage of the total area of the dots 31b over the total area of the light reflecting sheet 30b, is the lowest in the area directly behind the area where the ambient temperature around the cold cathode tubes 17 becomes T1 and gradually decreases toward the end of the light reflecting sheet 30b.

With this configuration, the dot pattern occupancy increases along from the area directly behind the area where the ambient temperature around the cold cathode tubes 17 becomes T1 toward the end area of the light reflecting sheet 30b. The amount of the light reflected by the light reflecting sheet 30b is the smallest in the area directly behind the area where the ambient temperature around the cold cathode tubes 17 becomes T1, and gradually increases toward the end area of the light reflecting sheet 30b. As a result, the amount of reflected light is small in the area where the light emitting efficiency of the cold cathode tubes 17 is high, and it is large in the area where the light emitting efficiency of the cold cathode tubes 17 is low. With this compensation, the panel surface of the liquid crystal panel 11 is illuminated with the even amount of light.

In this embodiment, the dots 31b are formed by applying the fluorescent whitening agent.

By forming the dot patterns with the fluorescent whitening agent that is more likely to reflect light, the light reflectivity of the dots 31b can be increased. Therefore, the difference in the light reflectivity between the dots 31b and the light reflecting sheet 30b becomes large and thus a function for adjusting the amount of reflected light with the dot patterns can be enhanced.

In this embodiment, the dot pattern occupancy of the light reflecting sheet 30b can be controlled by changing the intervals between the dots 31b and the sizes of the dots 31b. The dot pattern occupancy is preferably set with such a simple means.

The present invention is not limited to the third and the fourth embodiments explained in the above description. The following embodiments may be included in the technical scope of the present invention, for example.

In the third embodiment, the black dots 31 are printed on the light reflecting sheet 30. However, other colors may be used as long as they are less likely to reflect light. Gray dots may be printed, for example.

In the third and the fourth embodiments, the dots are formed by printing on the light reflecting sheet. However, other methods including a metal evaporation method can be used when forming the dots with a metal containing material. In this case, areas where the dots area not formed should be masked.

In the third and the fourth embodiment, the dots are formed in a parallel arrangement. However, they may be arranged in a zigzag arrangement. Moreover, the dots are arranged in line along the axial direction of the cold cathode tubes in the above embodiments. However, they may be arranged in an irregular pattern.

### Other Embodiments

The present invention is not limited to the above embodiments explained in the above description. The following embodiments may be included in the technical scope of the present invention, for example.

(1) In the above embodiments, the narrow pitch area 17a is located in the lower end area of the backlight device 12 and the wide pitch area 17b is located in the upper end area of the backlight device 12. However, the narrow pitch area and the wide pitch area can be provided in any other locations or the cold cathode tubes 17 may be arranged at an equal interval. However, arranging the cold cathode tubes 17 at small intervals in the lower end area of the backlight device 12 where the temperature is relatively low and at large intervals in the upper end area where the temperature is relatively high is preferable to smooth the temperature gradient.

(2) In the above embodiments, the cold cathode tubes are used as light sources. However, other types of light sources including hot cathode tubes can be used.

(3) In the above embodiments, the chassis is constructed of metal plates. However, it can be made of resin.

(4) In the above embodiments, the TFTs are used as switching components of the liquid crystal display device 10. However, the present invention can be applied to liquid crystal devices that use switching components other than the TFTs (e.g., thin film diodes (TFDs)). It also can be applied to a black and white liquid crystal display device other than the color liquid crystal display device.

(5) In the above embodiment, the liquid crystal display device using the liquid crystal panel 11 as a display panel. However, the present invention can be applied to display devices using different types of display panels.

TABLE 1

| | Light | Dot pattern | Average light |
|---|---|---|---|
| | reflectivity/% | occupancy/% | reflectivity/% |
| Light reflecting | 97.7 | — | 97.7 |
| sheet | | | |
| Black dot | 6.6 | 8.5 | 90.0 |
| | | 4.2 | 93.9 |
| | | 1.4 | 96.5 |
| Gray dot | 51.8 | 8.5 | 93.8 |
| | | 4.2 | 95.8 |
| | | 1.4 | 97.1 |

TABLE 2

| | Light | Dot pattern | Average light |
|---|---|---|---|
| | reflectivity/% | occupancy/% | reflectivity/% |
| Light reflecting | 97.7 | — | 97.7 |
| sheet | | | |
| Dot with fluorescent | 98.8 | 8.5 | 97.8 |
| whitening agent | | | |

1. A display device comprising:
a display panel; and
a backlight device configured to supply light to said display pane, wherein:
said backlight device includes a light source and a light reflecting member disposed on
a side opposite from a light emitting side of said light source;
said light source has a light emitting efficiency that is highest when an ambient temperature around said light source is T1; and
said light reflecting member has light reflectivity that is lowest in an area directly behind an area where the ambient temperature becomes T1 and increases along from the area directly behind the area where the ambient temperature becomes T1 toward an end area of said light reflecting member.

2. The display device according to claim 1, wherein:
the area directly behind the area where the ambient temperature becomes T1 is located in an upper end area of said light reflecting member; and
the light reflectivity of said light reflecting member increases along from the upper end area toward a lower end area of said light reflecting member.

3. The display device according to claim 1, wherein:
the area directly behind the area where the ambient temperature becomes T1 is located in a lower end area of said light reflecting member; and
the light reflectivity of said light reflecting member increases along from the lower end area toward an upper end area of said light reflecting member.

4. The display device according to claim 1, wherein:
the area directly behind the area where the ambient temperature becomes T1 is located in a middle area of said light reflecting member between an upper end area and a lower end area of said light reflecting member; and
the light reflectivity of said light reflecting member increases along from the middle area toward the upper end area and the lower end area of said light reflecting member.

5. The display device according to claim 1, wherein:
said backlight device further includes a chassis configured to house said light source and said light reflecting member;
said chassis has light reflectively lower than that of said light reflecting member;
said light reflecting member has a plurality of apertures; and
said apertures has an aperture ratio that is a total area of the apertures over that of said light reflecting member, said aperture ratio being highest in the area directly behind the area where the ambient temperature around said light source becomes T1 and gradually decreasing toward the end area of said light reflecting member.

6. The display device according to claim 5, wherein said chassis has a surface facing said light source and painted in any one of gray and black.

7. The display device according to claim 5, further comprising any one of gray member and black member between said light reflecting member and said chassis.

8. The display device according to claim 1, wherein:
said backlight device further includes a chassis configured to house said light source and said light reflecting member;
said chassis has light reflectively higher than that of said light reflecting member;
said light reflecting member has a plurality of apertures; and
said apertures has an aperture ratio that is a total area of the apertures over that of said light reflecting member, said aperture ratio being lowest in an area directly behind the area where the ambient temperature around said light source becomes T1 and gradually increasing toward the end area of said light reflecting member.

9. The display device according to claim 8, wherein said chassis has a surface facing said light source and coated with a fluorescent whitening agent.

10. The display device according to claim 8, wherein said chassis has a surface facing said light source and coated with a vapor-deposited metal so as to shine.

11. The display device according to claim 8, further comprising a member coated with a fluorescent whitening agent between said light reflecting member and said chassis.

12. The display device according to claim 8, further comprising a member coated with a vapor-deposited metal between said light reflecting member and said chassis.

13. The display device according to claim 5, wherein said apertures are provided in said light reflecting member directly behind said light source.

14. The display device according to claim 5, wherein said aperture ratio is controlled by at least one of an interval between said apertures, a size of said apertures and a shape of said apertures.

15. The display device according to claim 5, further comprising a light source holding member configured to hold said light source to said chassis, wherein:
said light reflecting member has an insertion hole through which said light source holding member is inserted; and
said insertion hole is provided in a different size from said apertures.

16. The display device according to claim 5, further comprising a light source holding member for holding said light source to said chassis, wherein:
said light reflecting member has an insertion hole through which said light source holding member is inserted; and
said insertion hole is provided in a different shape from said apertures.

17. The display device according to claim 5, wherein said apertures are formed in a zigzag arrangement.

18. The display device according to claim 5, wherein said apertures are formed in a parallel arrangement.

19. The display device according to claim 5, wherein said apertures are formed by punching said light reflecting member.

20. The display device according to claim 5, wherein said apertures are formed by plotter cutting said light reflecting member.

21. The display device according to claim 5, wherein said apertures are formed by laser processing said light reflecting member.

22. The display device according to claim 1, wherein:
said light reflecting member includes a dot pattern having a plurality of dots;
said dot pattern has light reflectivity lower than that of said light reflecting member; and
said dot pattern has a dot pattern occupancy that is a total area of the dots over that of said light reflecting member, said dot pattern occupancy being highest in the area directly behind the area where the ambient temperature around said light source becomes T1 and gradually decreasing toward the end area of said light reflecting member.

23. The display device according to claim 22, wherein said dot pattern is provided in any one of gray and black.

24. The display device according to claim 1, wherein:
said light reflecting member includes a dot pattern having a plurality of dots;
said dot pattern has light reflectivity higher than that of said light reflecting member; and
said dot pattern has a dot pattern occupancy that is a total area of the dots over that of said light reflecting member, said dot pattern occupancy being lowest in the area directly behind the area where the ambient temperature around said light source becomes T1 and gradually increasing toward the end area of said light reflecting member.

25. The display device according to claim 24, wherein said dot pattern is formed by coating with a fluorescent whitening agent.

26. The display device according to claim 25, wherein said dot pattern is provided in an area of said light reflecting member directly behind said light source.

27. The display device according to claim 22, wherein said dot pattern occupancy is controlled by at least one of an interval between the dots, a size of the dots and a shape of the dots.

28. The display device according to claim 22, wherein said dot pattern is formed such that the dots are in a zigzag arrangement.

29. The display device according to claim 22, wherein said dot pattern is formed such that said dots are in a parallel arrangement.

30. The display device according to claim 22, wherein said dot pattern is formed by printing on said light reflecting member.

31. The display device according to claim 22, wherein said dot pattern is formed by vapor depositing a metal on said light reflecting member.

32. The display device according to claim 1, wherein:
said light source is constructed of a plurality of linear light sources arranged in parallel; and
said plurality of linear light sources are arranged at smaller intervals in a lower end area of said backlight device than in an upper end area of said backlight device.

33. The display device according to claim 1, wherein the said display panel is a liquid crystal display panel using liquid crystal.

34. A television receiver comprising a display device according to claim 33.
